(19) United States
(12) Patent Application Publication
(10) Pub. No.: US 2014/0082947 A1
(43) Pub. Date: Mar. 27, 2014

(54) METHOD FOR CREATING ATOMICALLY SHARP EDGES ON OBJECTS MADE OF CRYSTAL MATERIAL

(71) Applicant: RUBICON TECHNOLOGY, INC., BENSENVILLE, IL (US)

(72) Inventors: SUNIL PHATAK, Bensenville, IL (US); Faisal Nabulsi, Willowbrook, IL (US)

(73) Assignee: RUBICON TECHNOLOGY, INC., BENSENVILLE, IL (US)

(21) Appl. No.: 14/035,217

(22) Filed: Sep. 24, 2013

Related U.S. Application Data
(60) Provisional application No. 61/705,231, filed on Sep. 25, 2012.

(51) Int. Cl. B26B 9/00

(52) U.S. Cl. CPC B26B 9/00
USPC 30/345; 216/41

(57) ABSTRACT

A process to make atomically sharp cutting devices is described. The process may provide for a cost effective and efficient technique of producing the atomically sharp cutting devices made from single crystal material such as, for example, sapphire, silicon carbide, silicon, and the like. The process may include identifying and choosing a preferred geometric orientation of the crystal material where cleavage can be promoted along a preferred natural plane of the single crystal material, thus ultimately producing an atomically sharp edge. The single crystal material may be covered at select surface locations by a photo-resist material arranged in a predetermined alignment with reference to the preferred plane to prevent etching at unexposed surface portions while permitting etching at exposed surface portions of the single crystal material. An atomic edge may be created by physical cleaving once the etching has reached a predetermined end-point.

### CROSS-REFERENCE TO RELATED APPLICATIONS

This application claims priority and benefit of U.S. Provisional Application No. 61/705,231 filed on Sep. 25, 2012, the disclosure of which is incorporated by reference herein in its entirety.

### FIELD OF THE DISCLOSURE

The present disclosure relates to a method for creating atomically sharp edges on crystal material and, more particularly, to a method for creating atomically sharp edges on objects made from or containing crystal material such as, e.g., sapphire, silicon, or the like.

### BACKGROUND OF THE DISCLOSURE

Manufacturing of cutting devices such as, for example, knives, scalpels, razor blades, or similar devices, typically involves grinding and polishing techniques to create the edges of the cutting devices. Polishing and grinding can be a relatively costly and/or time consuming process. In mass production of these cutting devices, any time savings or cost savings to produce these devices may provide a significant advantage. Moreover, any improvement in the sharpness of the cutting edge itself may offer a significant advantage over the currently produced cutting devices.

### SUMMARY OF THE DISCLOSURE

The present disclosure provides for a process to make atomically sharp cutting devices. The process may provide for a cost effective and efficient technique of producing the atomically sharp cutting devices made from a single crystal material such as, for example, sapphire, silicon carbide, silicon, and the like. The process may be performed in a high production environment. The process may include identifying and choosing a preferred geometric orientation of the crystal material where cleavage may be promoted along a preferred natural plane of the single crystal material, thereby producing an atomically sharp edge. The single crystal material may be covered at select surface locations by a photo-resist material arranged in a predetermined alignment with reference to the preferred plane to prevent etching at unexposed surface portions while permitting etching at exposed surface portions of the single crystal material. The single crystal material may be etched in a chemical bath or etching bath to remove crystal material until a desired end-point has been reached. The single crystal material may be physically cleaved along a created trough formed by the etching. The physical cleaving may produce a sharp atomic edge. Steps of a process may be performed to create either a one-sided cutting edge or a two-sided cutting edge on one or more cutting devices.

In one aspect, a process for producing a cutting device is provided comprising the steps of determining a preferred plane within a crystalline material, etching at least one unprotected part of the crystalline material to produce at least one facet in the crystalline material along the preferred plane and cleaving the crystalline material oriented with respect to an end of the at least one facet to create a cutting device.

In one aspect, a process for producing a cutting device is provided, comprising the steps of applying a photo-resist layer to at least one surface of a single crystal material, etching the single crystal material to produce at least one facet, and cleaving the single crystal material along an edge of the produced at least one facet to create a sharp cutting device. The process may further comprising the step of determining a preferred plane within a crystalline material, wherein the applying step applies the photo-resist layer with respect to the orientation of the preferred plane. The etching may produce a plurality of facets. The at least one surface may be a plurality of surfaces including a first surface and a second surface, and the etching step may etch the first surface and the second surface to produce a plurality of facets. The plurality of facets may form at least one trough on a first side and form at least one trough on a second side of the crystalline material. An apex may be formed on each side by the plurality of facets are aligned with respect to a determined preferred plane within the crystalline material.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate examples of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a sapphire wafer 100, according to principles of the disclosure;

FIG. 2 shows an example of a photo-resist layer 105 applied to the sapphire wafer 100, according to principles of the disclosure;

FIG. 3 shows the sapphire wafer 100 with selected areas of the photo-resist material removed to expose areas 110, according to principles of the disclosure;

FIG. 4 shows an example of an effect of the etching process on a sapphire wafer 100, according to principles of the disclosure;

FIG. 5 shows an example of a choice of crystal orientation, according to principles of the disclosure;

FIG. 6 shows an example of the effects of etching that has progressed towards the “end-point,” according to principles of the disclosure;

FIG. 7 shows an example of a cutting edge configured on a produced one-sided cutting device, as created by the chemical etching process, according to principles of the disclosure;

FIG. 8 shows an example of a sapphire wafer configured with photo-resist on two sides;

FIG. 9 shows a sapphire wafer with selected areas of the photo-resist material removed to expose select areas, according to principles of the disclosure;

FIG. 10 shows an example of an effect of the etching process on a sapphire wafer, according to principles of the disclosure;

FIG. 11 shows an example of the effects of etching that has progressed towards the “end-point,” according to principles of the disclosure;

FIG. 12 shows an example of a cutting edge configured on a produced two-sided cutting device as created by the etching process, according to principles of the disclosure;

FIG. 13 shows an example of an entire substrate such as a sapphire substrate as viewed from the top, according to principles of the disclosure; and

FIG. 14 is a flow diagram of an example process, the steps performed according to principles of the disclosure.

### The present disclosure is further described in the detailed description that follows.

### DETAILED DESCRIPTION OF THE DISCLOSURE

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the examples of the disclosure. The examples used herein are intended merely to facilitate an understanding of ways in which the disclosure may be practiced and to further enable those of skill in the art to practice the principles of the disclosure. Accordingly, the examples herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “computer-readable medium”, as used in this disclosure, means any physical medium that participates in providing data (for example, instructions) which may be read by a computer. Such a medium may take many forms, including non-volatile media, volatile media, and physical transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge as described hereinafter, or any other physical medium from which a computer can read. The computer-readable media may comprise non-transitory media.

The terms “including”, “comprising” and variations thereof, as used in this disclosure, mean “including, but not limited to”, unless expressly specified otherwise. The terms “a”, “an”, and “the”, as used in this disclosure, means “one or more”, unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The process of the present disclosure includes taking advantage of naturally occurring mechanical and chemical proprieties of single crystalline material such as, for example, sapphire, silicon carbide, silicon, and the like. For ease of explanation, this disclosure uses sapphire as an example of a single crystalline material, but it should be understood that the principles of the disclosure may apply to other single crystalline material (or monocrystalline solids) as well.

Sapphire has naturally occurring “cleavage planes.” When fractured, the sapphire crystal has a tendency to cleave or fracture along well defined crystal planes. By identifying and choosing a preferred geometric shape, cleavage can be promoted along a preferred plane, thus producing an atomically sharp edge.

Further, various crystalline orientations, or facets, of sapphire react to chemicals differently. The rate of chemical attack, or “etch rate,” is dependent, at least in part, on crystalline orientation of the surface and is typically asymmetric. The rate of chemical attack (or reaction) may also depend on the chemical composition employed, since different chemical formulations (e.g., acids) will have different reaction rates. A process to shaping a sapphire crystal may take advantage of this natural property in such a manner as to produce favorable geometric features which make cleaving along preferred planes easy, predictable, and reproducible.

FIG. 1 is an example of a sapphire wafer 100, according to principles of the disclosure. The sapphire crystal, or wafer, may be examined for plane orientation. The examination may be performed using commonly known crystallography x-ray scanning techniques so that the crystal may be aligned along a preferred plane within the crystal material. An example of this orientation is described in more detail in reference to FIG. 5 below. The dimensions, i.e., length, width and height, of the sapphire wafer 100 may be dependent on the type of cutting device to be manufactured.

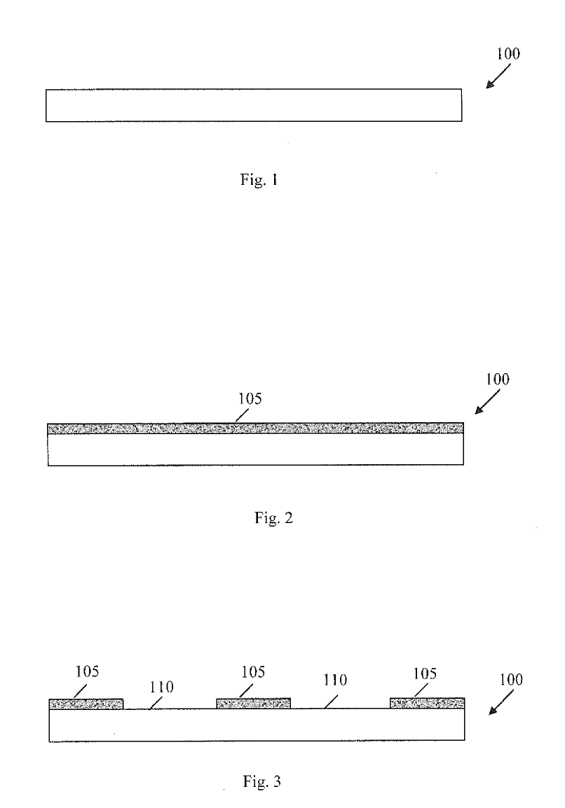

FIGS. 2 through 7 may be viewed as a series of steps that show an example of manufacturing a one-sided blade, according to principles of the disclosure. FIG. 2 is an example of a photo-resist layer 105 applied to the sapphire wafer 100, according to principles of the disclosure. The photo-resist layer 105 may be applied and located on the surface of the wafer 100 to orient the crystalline structure so that the identified preferred plane is oriented as described in reference to FIG. 5. The photo-resist layer 105 may be used to prevent the acid bath (described below) from contacting the sapphire wafer 100 at selected areas. Photo-resist materials are commonly available from companies such as, for example: AZ Electronics Materials of Branchburg, N.J., MacDermid Inc. of Denver, Colo., or Fujifilm Electronic Materials, Japan.

FIG. 3 shows an example of the sapphire wafer 100 with selected areas of the photo-resist material removed to expose areas 110, according to principles of the disclosure. The exposed areas 110 may be immersed in an acid bath to start the etching of the exposed areas 110. A suitable chemical bath for etching a sapphire may be (or may include), for example, a mixture of sulfuric acid (H₂SO₄) and phosphoric acids (H₃PO₄) in about a 3:1 ratio of sulfuric acid to phosphoric acid at about 350° C. Other acids may be used without departing from the scope or spirit of the disclosure. Moreover, other concentrations of acids and temperatures may be used, such as, e.g., to alter the etch rate.

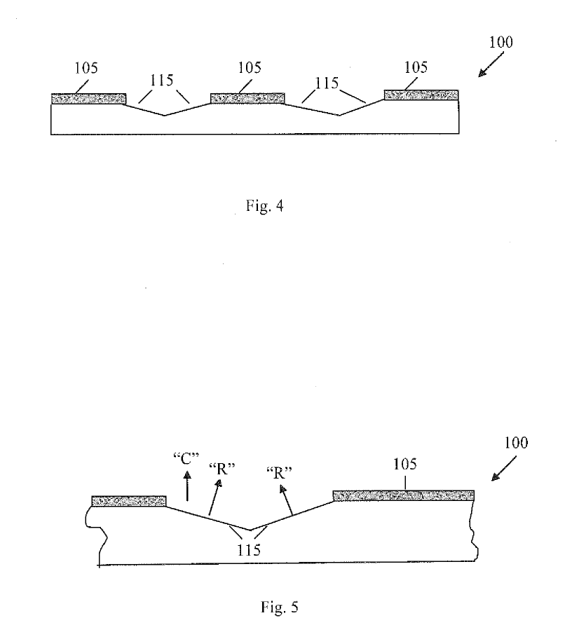

FIG. 4 shows an example of an effect of the etching process on a sapphire wafer 100, according to principles of the disclosure. As the exposed areas 110 of the sapphire wafer 100 contacts the acid bath, the crystal structure is etched away as illustrated to create facets 115, which form one or more generally “V” or “U” shaped troughs. The progress of the etching may be related to the orientation of the crystal and the preferred selected plane. Although the process described herein refers to “V” shaped troughs, it should be understood that essentially any concave shape such as a “U” shaped trough may be possible.

FIG. 5 shows an example of a choice of crystal orientation, according to principles of the disclosure. The crystal orientation is chosen along the “C” plane (as may be determined by x-ray examination, for example), then the etched planes may proceed along the “R” planes, as shown in the enlarged sectional view of the sapphire wafer 100. Orientation of the crystal along the “C” plane, and application of the photo-resist layer 105 in relation to this “C” plane, provides the necessary effect of producing the “V” shape of the facets 115. This “V” shape ultimately becomes the atomic edge of the cutting device as describe in more detail below.

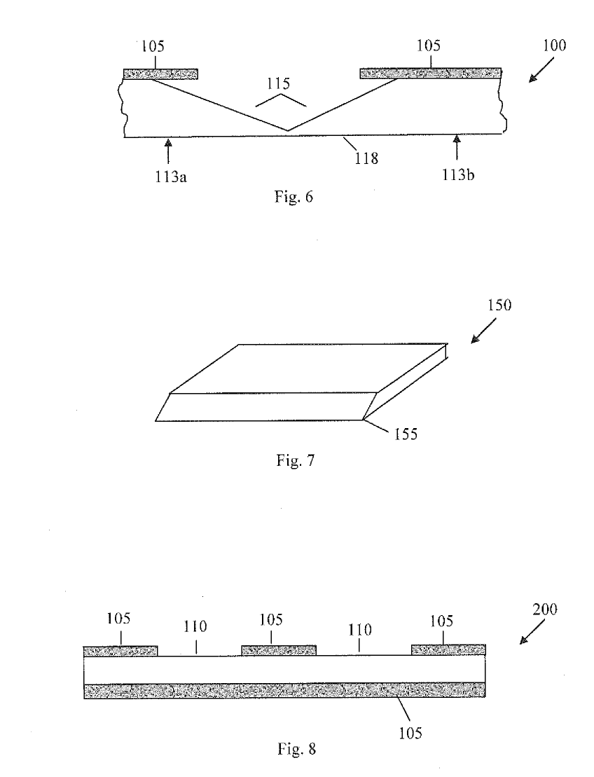

FIG. 6 is an example illustration showing the effects of etching that has progressed towards the “end-point,” according to principles of the disclosure. That is, as the etching time progresses to the end-point as determined by a predetermined time period for etching, or by optic monitoring (such as by machine visioning) of the remaining thickness at the apex 118 of the “V” on at least one side of the wafer 100, the thickness at the apex 118 approaches a thickness that may permit ideal physical cleaving of the sapphire wafer 100. A predetermined end-point may include that the thickness at the apex 118 be less than about 30 microns, for example. Often this end-point goal may approach about 15 microns or less. Once the end-point is achieved, the acid bath is no longer needed for this production cycle. Stopping the etching at the predetermined end-point is desirable to prevent the acid from etching through the sapphire completely, which, if permitted to proceed, may result in a less sharp cutting edge. Moreover, once the end-point goal (e.g., a desired depth of the “V”, or a predetermined thickness at the apex 118) has been achieved, the sapphire wafer 100 may be cleaved physically (e.g., broken) along the “V” trough, producing two cutting devices, each having an extremely sharp edge. The physical cleaving results in the sapphire material cleaving along the facet surfaces 115 proximate the apex 118 to produce an extremely sharp edge on each of the resulting two portions 113a, 113b. The photo-resist 105 may be removed before or after the cleaving. If a sapphire wafer 100 is configured to have multiple exposed areas 110 (such as shown in FIG. 3), then multiple cutting devices may be produced from the multiple portions of the sapphire wafer 100.

The etch rate may vary. For example, the etch rate may range from, e.g., about 1 to 2 microns per minute, although other time periods may be used, as appropriate. The specific crystal material used, the specific etching bath and/or its concentration, may contribute to varying etch rates.

FIG. 7 shows an example of a cutting edge 155 configured on a produced one-sided cutting device 150 which may result from one of the portions 113a, 113b as created by the chemical etching process, according to principles of the disclosure.

FIGS. 8-12 show an example of a process for producing a two-sided blade produced by the etching process, according to principles of the disclosure. The process for producing a two-sided blade is similar to the process for producing a one-sided blade, except that both a first side and a second side of a sapphire wafer 200 may be configured with photo-resist 105, each side substantially mirroring the other as to the locations where the photo-resist may be applied. FIG. 8 is an example of a sapphire wafer 200 configured with photo-resist on two sides. The location of the photo-resist 105 on the first side and the location of the photo-resist 105 on the second side are aligned to assure very close symmetry in the resulting opposing “V” shaped or “U” shaped troughs on each side of the sapphire wafer 200, as described below.

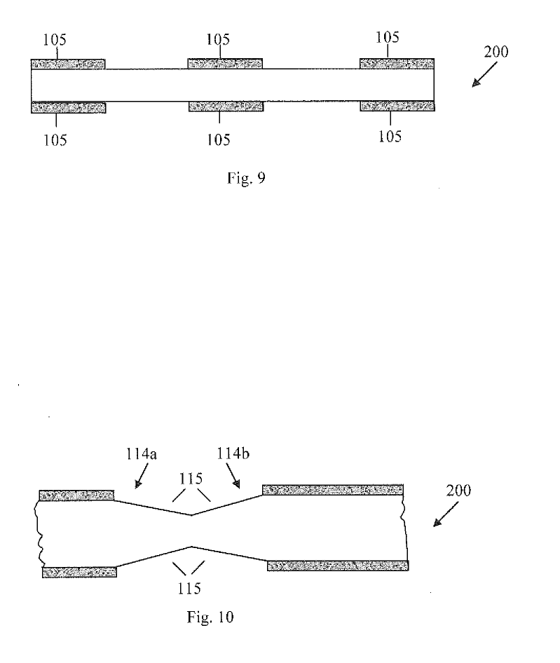

FIG. 9 shows the sapphire wafer 200 with selected areas of the photo-resist material removed (or not applied) exposing areas 110, according to principles of the disclosure. FIG. 9 shows a photo-resist layer being applied to both sides of the wafer 200 on selected parts of the surfaces of wafer 200. The exposed areas 110 (not having a photo-resist layer applied) when immersed in an etching solution, e.g., an acid bath (as described previously) initiates etching of the exposed areas 110. The etching proceeds to create the “V” or “U” troughs on both sides of the wafer 200, with a high degree of symmetry.

FIG. 10 shows an example of an effect of the etching process on a sapphire wafer 200, according to principles of the disclosure. As the exposed areas 110 of the sapphire wafer 200 contact the acid bath, the crystal structure is etched away as illustrated to create facets 115, which form one or more generally “V” shaped or “U” shaped troughs on each side of the sapphire wafer 200. The facets 115 being created on both sides of the wafer 200 may begin to converge towards a common point, which may be substantially midway between the two opposing sides of the wafer 200. Essentially, the apex of the “V” or “U” trough being formed on a first side of the wafer 200 and the apex of the “V” or “U” trough being formed on the second side of the wafer 200 tend to converge towards a common location, approximately at a mid-point of the wafer's thickness. The progress of the etching may be related to the orientation of the crystal and the preferred selected plane.

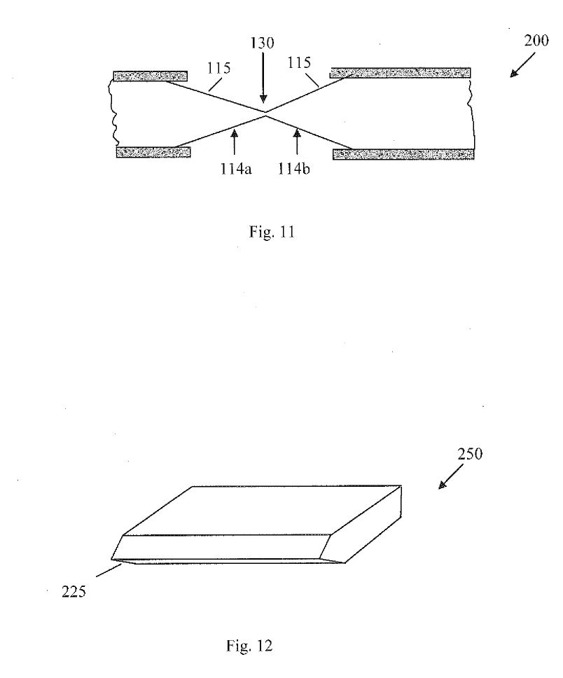

FIG. 11 shows an example of the effects of etching that has progressed towards the “end-point,” according to principles of the disclosure. That is, as the etching time progresses to the end-point as determined by a predetermined time period for etching, or by optic monitoring (such as by machine visioning) of the remaining thickness at the apex 130 of the double “V,” the thickness at the apex 130 approaches a thickness that may permit ideal physical cleaving of the sapphire wafer 200. A predetermined end-point may include, e.g., a thickness at which the apex 130 is less than, e.g., about 30 microns. Often this end-point goal (e.g., as determined by a predetermined time period for etching, or by optic monitoring (such as by machine visioning) may be a thickness that approaches, e.g., about 15 microns, or less.

Once the end-point is achieved, the acid bath is no longer needed for this production cycle. Stopping the etching at the predetermined end-point is desirable to prevent the acid from etching through the sapphire completely, which if permitted to proceed, may result in a less sharp cutting edge. Moreover, once the end-point goal has been achieved, the sapphire wafer 200 may be cleaved physically along the double “V” trough, producing two cutting devices, each having an extremely sharp edge. The physical cleaving results in the sapphire material cleaving along the facet surfaces 115 proximate the apex 130 to produce an extremely sharp edge on each of the resulting two portions 114a, 114b. The photo-resist 105 may be removed before or after the cleaving. If a sapphire wafer 200 is configured to have multiple exposed areas 110 on each side of the sapphire wafer 200 (such as shown in FIG. 9), then multiple two-sided cutting devices may be produced from the multiple portions of the sapphire wafer 200.

FIG. 12 shows an example of a cutting edge 225 configured on a produced two-sided cutting device 250, which may result from one of the portions 114a, 114b (FIG. 11) as created by a chemical etching process, according to principles of the disclosure.

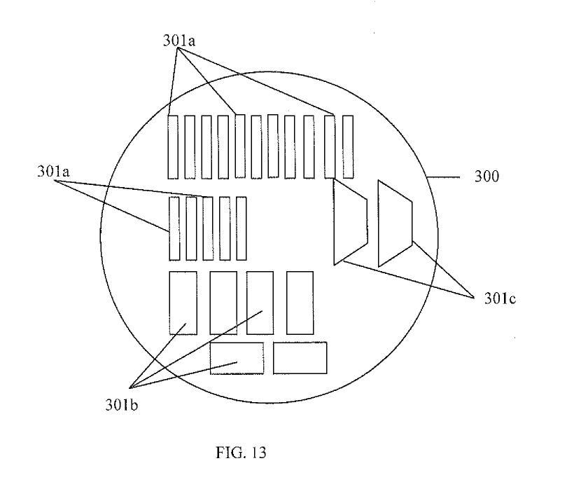

FIG. 13 shows an example of an entire substrate such as a sapphire substrate as viewed from the top. This example shows that multiple cutting devices 301a-301c, perhaps having different shapes, may be “printed” on the starting substrate 300 and may be processed simultaneously by the etching process described above. This may be analogous to processing by the commercial microelectronics industry for producing electronic circuits. Thus, it is possible to manufacture multiple, even hundreds, of cutting devices to obtain true economy of scale. Further, multiple substrates 300 can be processed per the above-described etching process in the same overall process cycle, similar to the microelectronics industry practices of producing electronic circuits on a large scale.

It is to be noted that multiple cutting device designs (e.g., size, shape) 301a-301c may be included in the same substrate during the creation of original photo mask used for imprinting into the photoresist layer. All these designs 301a-301c may be processed simultaneously during an etching process cycle described above.

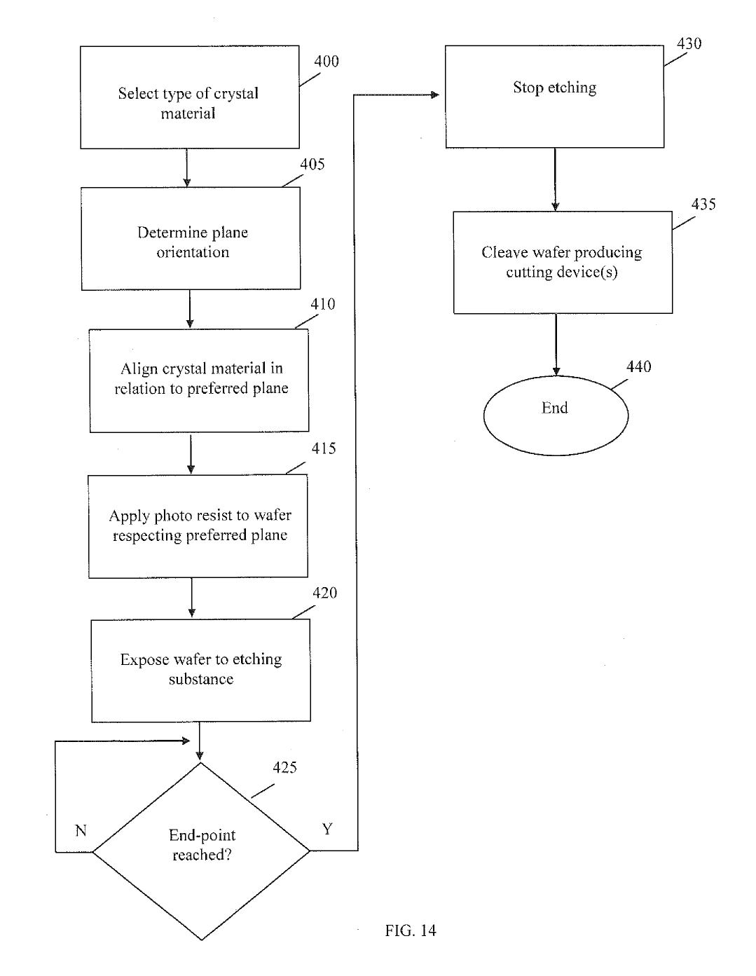

FIG. 14 is a flow diagram of a process for producing an atomically sharp edge on crystal material, the steps performed according to principles of the disclosure. The steps of the flow diagram of FIG. 14 may also represent a block diagram for components to perform the respective steps. The respective steps may be performed or controlled by a computer that is programmed with computer software to execute the respective step. The computer software for the respective steps may be stored in a computer readable medium that when read and executed by the computer, performs the respective step. The computer software and computer readable medium may comprise a computer program product.

At step 400, a selection is made of the type of crystal material to be used to make an atomically sharp edge or edges. The type of crystal material may be selected from single crystalline material such as, for example, sapphire, silicon carbide, silicon and the like. The selection of the type of material may be based on the type of end device required. The crystal material may be in the form of a wafer. At step 405, a determination may be made of the crystal orientation and one or more planes therewithin. This may be accomplished by x-ray crystallography, for example. At step 410, the crystal material may be characterized for receiving photo-resist with respect to the alignment of a selected preferred plane within the crystal. The crystalline material may be aligned in relation to the preferred plane for receiving the photo-resist layer. At step 415, photo-resist layering may be applied to the surface of the crystalline material so that the subsequent etching proceeds by creating “V” or “U” shapes in part of the crystalline material. The photo-resist layer may be applied with respect to the orientation of the preferred plane. The etching may produce at least one facet. The photo-resist layer may comprise multiple separate independent segments. The photo-resist layer may be applied to create one or more protected parts of the crystalline material to prevent etching of the one or more protected parts, wherein the at least one unprotected part of the crystalline material is not covered by the photo-resist layer to permit etching. At step 420, the crystalline material may be exposed to an etching substance or solution, such as, e.g., an acid bath. Exemplary types of acids for use as an acid bath and examples of acid concentrations usable in this process are described in relation to FIG. 3, above.

At step 425, a determination is made if an end-point has been reached. The determination may be accomplished by optic measurement techniques and/or the determination may include, e.g., at least one of: determining a depth of an apex of the “V” shaped or “U” shaped trough, determining a thickness at the apex, or identifying that a predetermined time duration has been reached for the etching phase. The predetermined time duration may be related to, e.g., the type of acid, the concentration of the acid, the type of crystalline material and/or the thickness of the crystalline material, or combinations thereof. If the end-point has not been reached, the etching process continues. If, however, the end-point has been reached, at 430, the etching is stopped, e.g., stopping exposure of the crystalline material to the acid. At step 435, the crystal material may be cleaved to produce one or more cutting devices having one or more atomically shaped edges. The cleaving may occur at an end of at least one facet. The one or more facets may be created by the “V” or “U” shaped troughs. The process may end at step 440.

The resulting cutting devices may be further shaped as needed in accordance with a particular application. For example, the cleaved cutting device may be cut to create a plurality of cutting devices, or the cutting devices may be further shaped to conform to a requirement of a holding instrument, such as, e.g., a handle, a retainer, an applicator, or the like.

The processes described herein may be automated for control by a computerized production line so that the steps of the process herein may be performed at high rates. One or more steps of the process may be performed under control of a computer and related computer code that may be configured to be loaded from a computer-readable medium and executed by a processor. The code in conjunction with appropriate hardware may be configured to perform some or all of the steps described herein. Such steps may include, but are not limited to, choosing the sapphire crystal orientation along the “C” plane or other preferred plane (as may be determined by x-ray examination, for example). The application of the photo-resist may be controlled by computerized control. Further, the etching process including sapphire wafer immersion may be controlled by computerized control. The step of determining if an end-point has been reached may be accomplish by computerized control, which may include timing the etching based on a predetermined end-point goal, or by optic measurement (as by machine visioning) of apex depths. Moreover, the physical cleaving may be controlled by computerized control in conjunction with appropriate hardware to accomplish the cleaving.

While the disclosure has been described in terms of exemplary embodiments, those skilled in the art will recognize that the disclosure can be practiced with modifications in the spirit and scope of the claims. These examples are merely illustrative and are not meant to be an exhaustive list of all possible designs, embodiments, applications or modifications of the disclosure.

What is claimed:

1. A process for producing a cutting device, comprising the steps of:
determining a preferred plane within a crystalline material;
etching at least one unprotected part of the crystalline material to produce at least one facet in the crystalline material along the preferred plane; and
cleaving the crystalline material oriented with respect to an end of the at least one facet to create a cutting device.

2. The process of claim 1, wherein the determining a preferred plane includes determining the preferred plane using x-rays.

3. The process of claim 1, further comprising the steps of:
applying a photo-resist layer to at least one surface of the crystalline material in relation to the determined preferred plane creating at least one protected part of the at least one surface of the crystalline material and the at least one unprotected part.

4. The process of claim 3, wherein the at least one surface is a plurality of surfaces including a first surface and a second surface and the photo-resist layer applied to the first surface of the crystalline material aligns with a photo-resist layer applied to the second surface to create protected parts on the surface of each side and to create the unprotected part on the first surface and to create an unprotected part on the second surface so that the unprotected parts on each surface align.

5. The process of claim 3, wherein the etching comprises etching the crystalline material with an etching bath, wherein the photo-resist layer is applied to created one or more protected parts of the crystalline material to prevent etching of the one or more protected parts, wherein the at least one unprotected part of the crystalline material is not covered by the photo-resist layer to permit etching.

6. The process of claim 3, further comprising determining if an end-point has been reached and stopping the etching when the end-point has been reached.

7. The process of claim 6, wherein the determining if an end-point has been reached includes determining at least one of: a depth of an apex of a “V” shaped or “U” shaped trough has been reached, a thickness at the apex of the “V” shaped or “U” shaped trough has been reached, and a predetermined time duration has occurred for the etching.

8. The process of claim 7, wherein the determining if an end-point has been reached determines that the thickness at the apex is less than about 30 microns.

9. The process of claim 7, wherein the determining if an end-point has been reached determines that the thickness at the apex is less than about 15 microns.

10. The process of claim 1, wherein the crystalline material is a single crystalline material selected from the group comprising: sapphire, silicon carbide and silicon.

11. The process of claim 10, wherein the crystalline material is in a wafer shape.

12. The process of claim 1, wherein the etching comprises etching the crystalline material with an etching solution.

13. A cutting device produced by process of claim 1.

14. A process for producing a cutting device, comprising the steps of:
applying a photo-resist layer to at least one surface of a single crystal material;
etching the single crystal material to produce at least one facet; and
cleaving the single crystal material along an edge of the produced at least one facet to create a sharp cutting device.

15. The process of claim 14, further comprising the step of determining a preferred plane within a crystalline material, wherein the applying step applies the photo-resist layer with respect to the orientation of the preferred plane.

16. The process of claim 14, wherein the etching produces a plurality of facets.

17. The process of claim 14, wherein the at least one surface is a plurality of surfaces including a first surface and a second surface, and the etching step etches the first surface and the second surface to produce a plurality of facets.

18. The process of claim 17, wherein the plurality of facets form at least one trough on a first side and form at least one trough on a second side of the crystalline material.

19. The process of claim 18, wherein an apex formed on each side by the plurality of facets are aligned with respect to a determined preferred plane within the crystalline material.

20. The process of claim 19, wherein the cleaving step cleaves along the apex formed on each side to produce a sharp cutting device.

21. The process of claim 14, further comprising determining if an end-point has been reached and stopping the etching when the end-point has been reached.

22. The process of claim 14, wherein the single crystalline material is selected from the group comprising: sapphire, silicon carbide and silicon.

23. The process of claim 14, wherein the photo-resist layer comprises a photo-resist layer.

24. The process of claim 14, wherein each step is computer controlled.

25. A cutting device produced by the process of claim 14.
